(19) United States
(12) Patent Application Publication
(10) Pub. No.: US 2020/0387802 A1
(43) Pub. Date: Dec. 10, 2020

(54) DYNAMICALLY ADAPTABLE RULES AND COMMUNICATION SYSTEM FOR MANAGING PROCESS CONTROLS

(71) Applicant: TrustArc Inc, San Francisco, CA (US)

(72) Inventor: Hilary M. Wandall, Center Valley, PA (US)

(21) Appl. No.: 16/894,769

(22) Filed: Jun. 6, 2020

Related U.S. Application Data
(60) Provisional application No. 62/858,980, filed on Jun. 8, 2019.
(60) Provisional application No. 62/858,979, filed on Jun. 8, 2019.

(51) Int. Cl. G06N 5/00; G06F 16/22; G06N 5/02; G06F 8/41

(52) U.S. Cl. CPC G06N 5/003; G06F 8/433; G06N 5/025; G06F 16/2246

(57) ABSTRACT

A method, system and/or computer usable program product for receiving a dynamic profile of an entity, the dynamic profile including relevant attributes and a set of data flow models representing process controls for the entity; receiving a dynamic set of use case rules, each set of use case rules corresponding to at least one of the set of use cases, for assessing the set of use cases with the entity based on the dynamic profile of that entity; applying the dynamic set of use case rules against the dynamic entity profile to provide an assessment of the set of use cases with the entity in accordance with the use case rules, the assessment including any tasks to be performed based on the use case rules; providing the assessment, including tasks to be performed, to a managing user; and responsive to receiving an indication that the dynamic profile of the entity has been modified, automatically repeating the step of applying the dynamic set of use case rules against the dynamic entity profile to provide an assessment of the set of use cases with the entity and, automatically repeating the step of providing the assessment to the managing user.

### PRIORITY CLAIM

This application claims priority to U.S. Provisional Application No. 62/858,980, filed Jun. 8, 2019, entitled “DYNAMICALLY ADAPTABLE RULES AND COMMUNICATION SYSTEM FOR MANAGING PROCESS CONTROLS”, and claims priority to U.S. Provisional Application No. 62/858,979, filed Jun. 8, 2019, entitled “DYNAMICALLY ADAPTABLE RULES AND COMMUNICATION SYSTEM TO MANAGE PROCESS CONTROL-BASED USE CASES”, the disclosures of which are incorporated in their entirety herein by reference.

### BACKGROUND

### Technical Field

The present invention relates generally to a dynamically adaptable rules and communication system, and more specifically to a computer-implemented method for generating and managing data flow models representing process controls for use cases in accordance with the use case control requirements.

### Description of Related Art

With the advent of the internet and mass communications of data worldwide, a host of data management issues have arisen. Many entities are gaining and sharing access to an increasingly large variety of data types, including personal data, much of which may be sensitive. In addition, this is occurring among a proliferation of data privacy, security policies, export controls, etc. For example, various governments, standard bodies and other entities have instituted a large variety of laws, regulations or rules addressing and enforcing certain data management policies. As a result, it is becoming substantially more difficult to manage the use and sharing of data types while complying with a multitude of laws, regulations and rules.

Whether certain laws regulations or rules apply to an entity's process controls for a given use case depends on a variety of conditions including the type of entity, where the entity and its workers are located, the size of the entity, the type of data accessed or shared, the location of where the data was accessed or shared, the sensitivity of the data, etc. In addition, determining compliance and maturity of the entity's process controls with applicable laws, regulations or rules is a complex and formidable task.

An example of mapping multiple governance, risk and compliance (GRC) mandates against each other in order to identify “common controls” is provided by the Unified Compliance Framework (UCF). UCF maintains a database of mandate “authority documents”, mandate citations, common controls and a defined terms dictionary. The UCF allows a user to input mandates of interest and to map the mandates on a one to one, one to many and many to many basis in order to produce a hierarchical list of common controls among the selected mandates. These common controls are linked to roles, assets, records, activities, events and audit questions. This list and related reports help UCF users identify overlaps among mandates, identify and remedy gaps in the user organization's GRC program and support a compliance audit program.

### SUMMARY

The illustrative embodiments of the present invention provide a method, system, and/or computer usable program product for receiving a dynamic profile of an entity, the dynamic profile including relevant attributes and a set of data flow models representing process controls for the entity; receiving a dynamic set of use case rules, each set of use case rules corresponding to at least one of the set of use cases, for assessing the set of use cases with the entity based on the dynamic profile of that entity; applying the dynamic set of use case rules against the dynamic entity profile to provide an assessment of the set of use cases with the entity in accordance with the use case rules, the assessment including any tasks to be performed based on the use case rules; providing the assessment, including tasks to be performed, to a managing user; and responsive to receiving an indication that the dynamic profile of the entity has been modified, automatically repeating the step of applying the dynamic set of use case rules against the dynamic entity profile to provide an assessment of the set of use cases with the entity and, automatically repeating the step of providing the assessment to the managing user.

### BRIEF DESCRIPTION OF THE DRAWINGS

The novel features believed characteristic of the invention are set forth in the appended claims. The invention itself, further objectives and advantages thereof, as well as a preferred mode of use, will best be understood by reference to the following detailed description of illustrative embodiments when read in conjunction with the accompanying drawings, wherein:

FIG. 1 provides a block diagram of an illustrative data processing system in which various embodiments of the present disclosure may be implemented;

FIG. 2 provides a block diagram of an illustrative network of data processing systems in which various embodiments of the present disclosure may be implemented;

FIG. 3 provides a high level block diagram of a system of multiple interacting modules utilized to dynamically and automatically manage process control-based use cases, including to generate and manage data flow models, in which various embodiments of the present disclosure may be implemented;

FIGS. 4A-D provide high level flow diagrams for each of the multiple interacting modules utilized to generate and manage data flow models for use cases in which various embodiments of the present disclosure may be implemented;

FIGS. 5A-5B provide block diagrams of database records utilized to manage process control-based use cases in which various embodiments of the present disclosure may be implemented;

FIG. 6 provides a block diagram of a data flow model representing process controls for use cases in which various embodiments of the present disclosure may be implemented;

FIG. 7 provides a block diagram of a graphical user interface managing user may use to manage assessments and tasks in which various embodiments of the present disclosure may be implemented; and

FIG. 8 provides a flow diagram of the use case management engine managing process control-based use cases in which various embodiments of the present disclosure may be implemented.

### DETAILED DESCRIPTION

Processes and devices may be implemented and utilized for a process controls management system for use cases. These processes and apparatuses may be implemented and utilized as will be explained with reference to the various embodiments below.

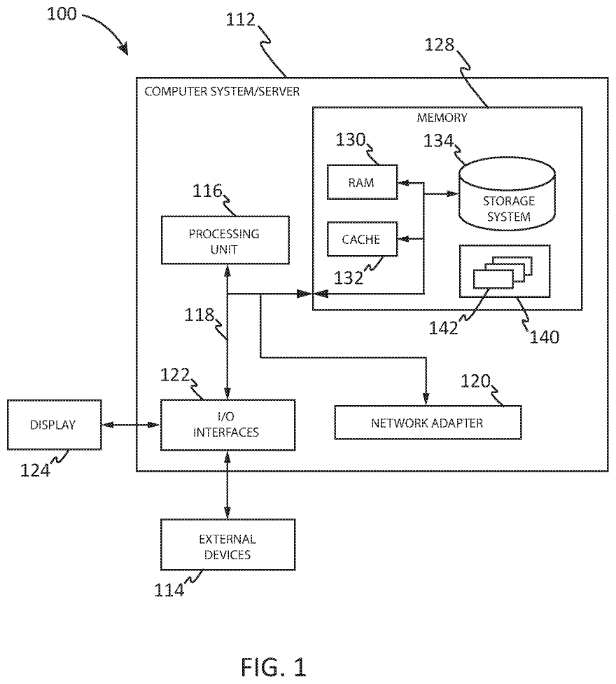

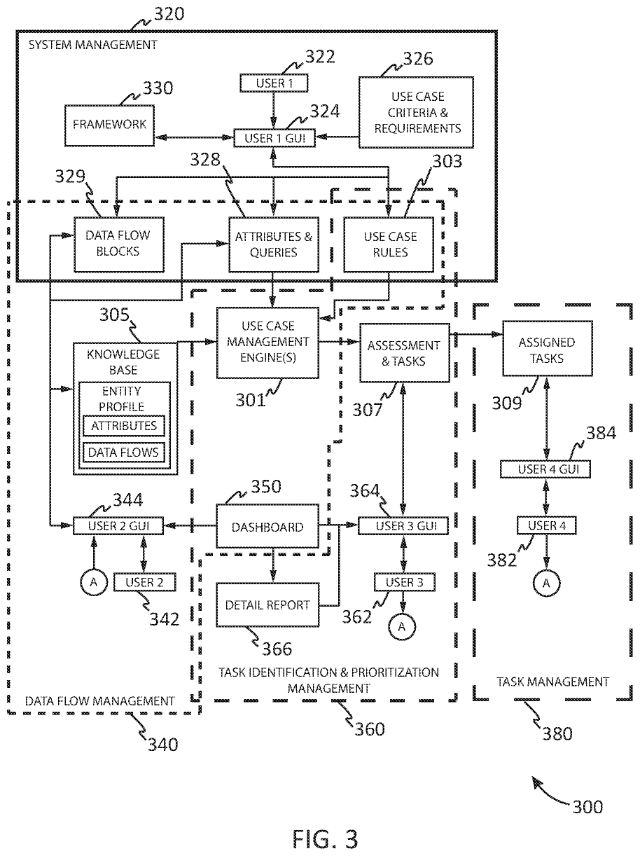

FIG. 1 provides a block diagram of an illustrative data processing system in which various embodiments of the present disclosure may be implemented. Data processing system 100 is one example of a suitable data processing system and is not intended to suggest any limitation as to the scope of use or functionality of the embodiments described herein. Regardless, data processing system 100 is capable of being implemented and/or performing any of the functionality set forth herein such as a process controls management system for use cases. Use cases may include a variety of policies for managing the use and dissemination of certain types of data. These policies typically require the use of one or more sets of process controls for managing the use and dissemination of these types of data within or among corporate entities and individuals. These policies may be generated by governmental bodies, standards organizations, within a corporate entity, or other possible sources. Some examples of use cases are provided below with reference to FIG. 3.

In data processing system 100 there is a computer system/server 112, which is operational with numerous other general purpose or special purpose computing system environments, peripherals, or configurations. Examples of well-known computing systems, environments, and/or configurations that may be suitable for use with computer system/server 112 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 112 may be described in the general context of computer system-performable instructions, such as program modules, being processed by a computer system. Generally, program modules may include routines, programs, objects, components, logic, data structures, and so on that perform particular tasks or implement particular abstract data types. Computer system/server 112 may be practiced in distributed computing environments where tasks are performed by remote processing devices that are linked through a communications network. In a distributed computing environment, program modules may be located in both local and remote computer system storage media including memory storage devices.

As shown in FIG. 1, computer system/server 112 in data processing system 100 is shown in the form of a general-purpose computing device. The components of computer system/server 112 may include, but are not limited to, one or more processors or processing units 116, a system memory 128, and a bus 118 that couples various system components including system memory 128 to processor 116.

Bus 118 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 112 typically includes a variety of non-transitory computer system usable media. Such media may be any available media that is accessible by computer system/server 112, and it includes both volatile and non-volatile media, removable and non-removable media.

System memory 128 can include non-transitory computer system readable media in the form of volatile memory, such as random-access memory (RAM) 130 and/or cache memory 132. Computer system/server 112 may further include other non-transitory removable/non-removable, volatile/non-volatile computer system storage media. By way of example, storage system 134 can be provided for reading from and writing to a non-removable, non-volatile magnetic media (not shown and typically called a “hard drive”). Although not shown, a USB interface for reading from and writing to a removable, non-volatile magnetic chip (e.g., a “flash drive”), and an optical disk drive for reading from or writing to a removable, non-volatile optical disk such as a CD-ROM, DVD-ROM or other optical media can be provided. In such instances, each can be connected to bus 118 by one or more data media interfaces. Memory 128 may include at least one program product having a set (e.g., at least one) of program modules that are configured to carry out the functions of the embodiments. Memory 128 may also include data that will be processed by a program product.

Program/utility 140, having a set (at least one) of program modules 142, may be stored in memory 128 by way of example, and not limitation, as well as an operating system, one or more application programs, other program modules, and program data. Each of the operating system, one or more application programs, other program modules, and program data or some combination thereof, may include an implementation of a networking environment. Program modules 142 generally carry out the functions and/or methodologies of the embodiments. For example, a program module may be software for a process controls management system for use cases.

Computer system/server 112 may also communicate with one or more external devices 114 such as a keyboard, a pointing device, a display 124, etc.; one or more devices that enable a user to interact with computer system/server 112; and/or any devices (e.g., network card, modem, etc.) that enable computer system/server 112 to communicate with one or more other computing devices. Such communication can occur via I/O interfaces 122 through wired connections or wireless connections. Still yet, computer system/server 112 can communicate with one or more networks such as a local area network (LAN), a general wide area network (WAN), and/or a public network (e.g., the Internet) via network adapter 120. As depicted, network adapter 120 communicates with the other components of computer system/server 112 via bus 118. It should be understood that although not shown, other hardware and/or software components could be used in conjunction with computer system/server 112. Examples, include, but are not limited to: microcode, device drivers, tape drives, RAID systems, redundant processing units, data archival storage systems, external disk drive arrays, etc.

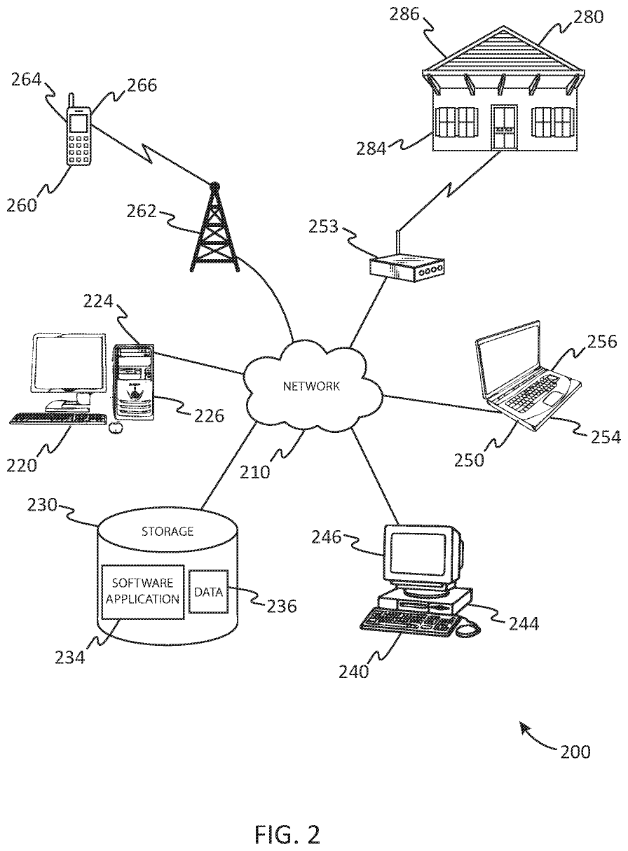

FIG. 2 provides a block diagram of an illustrative network of data processing systems in which various embodiments of the present disclosure may be implemented. Data processing environment 200 is a network of data processing systems such as described above with reference to FIG. 1. Software applications such as for a process controls management system for use cases may be processed on any computer or other type of data processing system in data processing environment 200. Data processing environment 200 includes network 210. Network 210 is the medium used to provide simplex, half duplex and/or full duplex communications links between various devices and computers connected together within data processing environment 200. Network 210 may include connections such as wire, wireless communication links, or fiber optic cables.

Server 220 and client 240 are coupled to network 210 along with storage unit 230. In addition, laptop 250 and facility 280 (such as a home or business) are coupled to network 210 including wirelessly such as through a network router 253. A mobile device 260 such as a mobile phone may be coupled to network 210 through a cell tower 262. Data processing systems, such as server 220, client 240, laptop 250, mobile device 260 and facility 280 contain data and have software applications including software tools processing thereon. Other types of data processing systems such as personal digital assistants (PDAs), smartphones, tablets and netbooks may be coupled to network 210.

Server 220 may include software application 224 and data 226 for a process controls management system for use cases or other software applications and data in accordance with embodiments described herein. Storage 230 may contain software application 234 and a content source such as data 236 for a process controls management system for use cases. Other software and content may be stored on storage 230 for sharing among various computer or other data processing devices. Client 240 may include software application 244 and data 246. Laptop 250 and mobile device 260 may also include software applications 254 and 264 and data 256 and 266. Facility 280 may include software applications 284 and data 286 on local data processing equipment. Other types of data processing systems coupled to network 210 may also include software applications. Software applications could include a web browser, email, or other software application for a process controls management system for use cases.

Server 220, storage unit 230, client 240, laptop 250, mobile device 260, and facility 280 and other data processing devices may couple to network 210 using wired connections, wireless communication protocols, or other suitable data connectivity. Client 240 may be, for example, a personal computer or a network computer.

In the depicted example, server 220 may provide data, such as boot files, operating system images, and applications to client 240 and laptop 250. Server 220 may be a single computer system or a set of multiple computer systems working together to provide services in a client server environment. Client 240 and laptop 250 may be clients to server 220 in this example. Client 240, laptop 250, mobile device 260 and facility 280 or some combination thereof, may include their own data, boot files, operating system images, and applications. Data processing environment 200 may include additional servers, clients, and other devices that are not shown.

In the depicted example, data processing environment 200 may be the Internet. Network 210 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 200 also may be implemented as a number of different types of networks, such as for example, an intranet, a local area network (LAN), or a wide area network (WAN). FIG. 2 is intended as an example, and not as an architectural limitation for the different illustrative embodiments.

Among other uses, data processing environment 200 may be used for implementing a client server environment in which the embodiments may be implemented. A client server environment enables software applications and data to be distributed across a network such that an application functions by using the interactivity between a client data processing system and a server data processing system. Data processing environment 200 may also employ a service-oriented architecture where interoperable software components distributed across a network may be packaged together as coherent business applications.

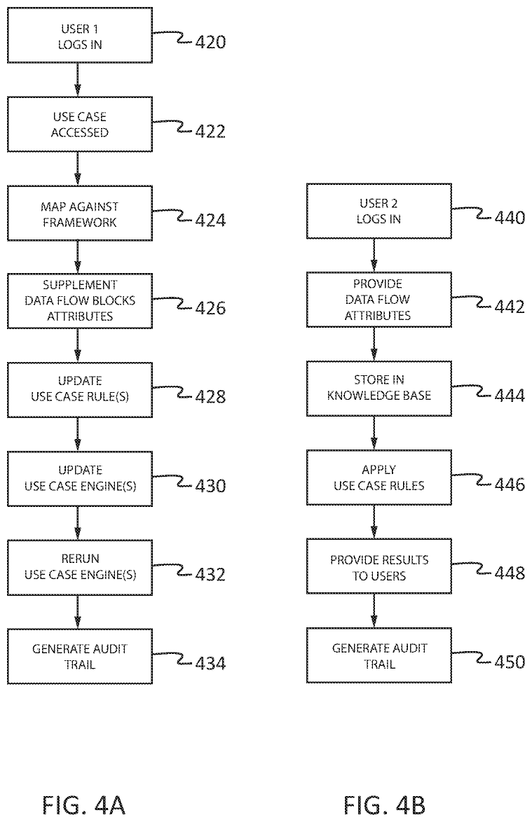

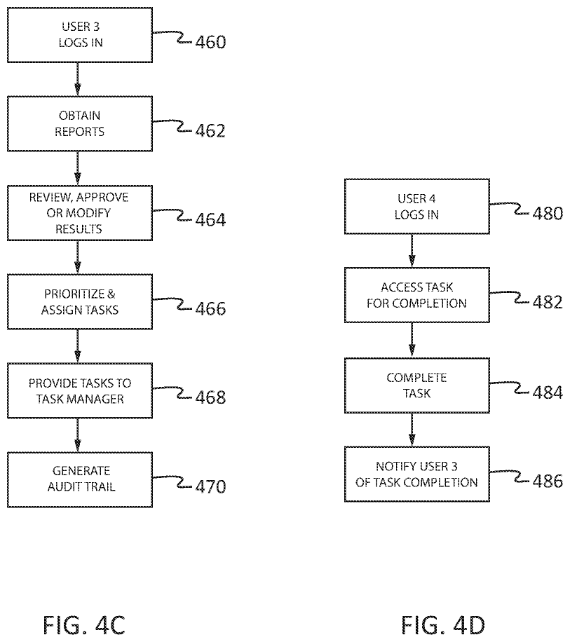

FIG. 3 provides a high level block diagram of a system of multiple interacting modules 300 utilized to dynamically and automatically manage process control-based use cases, including to generate and manage data flow models, in which various embodiments of the present disclosure may be implemented. These data flow models may be utilized for determining compliance with the use cases, but also for analyzing or otherwise assessing the data flow models using GRC (governance, risk management and compliance) analysis. This system is also a communications system, facilitating collaboration among multiple users in a structured but adaptable way, to create a more efficient, computer-enabled means of solving issues with managing applicability and compliance with process control-based use cases. High level flow diagrams for each of the multiple interacting modules are described below with reference to FIGS. 4A-4D. Interacting modules 300 include a system management module 320, a data flow management module 340, a task identification and prioritization management module 360 and a task management module 380. At the core of these modules for the present embodiment is an adaptable use case management engine(s) 301 which automatically applies a dynamic set of use case rules 303 against a developing and dynamic knowledge base 305 including an entity profile to provide a set of assessments and tasks 307. Knowledge base includes at least one entity profile, which may include a set of entity attributes and a set of entity data flow models. Assessments and tasks 307 may be modified, prioritized and otherwise managed by User 3 in accordance with an intelligent governance, risk management and compliance analysis towards generating and assigning a set of assigned tasks 309 including tasks for generating data flow models of data by the entity. The assessments and resulting tasks may be directed to compliance with the use case or they may be directed to developing a more mature system that meets recommended but not required process controls. The entity can specify a level of assessment through preferences stored in the present system. There may be multiple levels of assessment and those levels may differ by use case, entity or other desired criteria. The data flow models may be utilized to bring the entity into compliance and/or maturity with applicable use cases, to verify and document that compliance and/or maturity, and for additional analysis and management of the underlying process controls. As described herein, snapshots of elements 301-309, as well as other elements described below, may be preserved as they are modified for a variety of uses such as for generating an audit trail.

System management module 320 includes a User 1 322 interacting with a graphical user interface (GUI) 324 to manage the various elements of system management module 320. As described in greater detail below with reference to FIG. 4A, User 1 322 may utilize User 1 GUI 324 to generate, based on incoming use case criteria and requirements 326 and existing framework 330, a set of use case rules 303 which a use case management engine(s) 301 utilizes to determine applicability and compliance of the incoming use case to one or more entities including assessing the need for generating data flow models towards analyzing those use models for governance, risk analysis and compliance.

The present embodiment is described as an automated process control management system for developing a profile of an entity(ies) from both organization chart and business process data flow points of view in order automatically to determine the scope of laws, regulations, policies and other mandates (i.e., use cases) that apply to that particular entity. This entity profile, a subset of the knowledge base, as well as the rules to be applied against that profile, may be developed and updated collaboratively among multiple users in a structured but adaptable manner. An entity may be a single entity or multiple interrelated entities combined and treated as a single entity for purposes of describing the present embodiment. In the case of multiple interrelated entities, each entity may also be treated as a single entity as described below, then the result combined to determine the use cases that apply to the combined entity. Also, for multiple entities, data for and processing of the present embodiment may be maintained on separate virtual systems or as isolated copies with firewalls in-between for each entity or group of entities so as to preserve the confidentiality of data from other entities or groups of entities.

User 1322, also referred to herein as an administrative user, may be a single user, multiple users, a set of users with a given access profile, or other set of users authorized to utilize User 1 GUI 324. User 1 may also be the same as or separate from any other users (e.g., Users 2-4) shown herein. User 1 may also be from or support a different entity than other users. For example, User 1 may be from or supporting an entity managing software implementing this embodiment while other users may be from or supporting an entity applying the software implementing this embodiment to a specific entity. An entity may be a sole proprietorship, a partnership, a corporation or a set of interconnected entities such as a corporation and its subsidiaries. An entity also may be a set of processes performed by a generally defined set of users. A set of use case criteria and requirements for a use case 326 may be received, developed and/or approved by User 1 for generating of a set of use case rules 303, a set of attributes and queries 328, and a set of data flow blocks while utilizing framework 330. A use case may be a set of process controls or criteria (i.e., standards) to be met for a set of process controls for managing certain processes including regulatory, policy, contractual, code of other governing standard requirement such as privacy requirements, a set of governing standards received, generated and/or implemented by User 1, or other set of process control based governing requirements. Use cases may include privacy laws (laws that deal with the regulating, storing and using of personally identifiable information of individuals), including GDPR (General Data Protection Regulation) in Europe, CalOPPA (California Online Privacy Protection Act) in California, and numerous other privacy laws worldwide. Use case rules 303 may be a set of rules to determine whether a use case applies to an entity based on that entity's profile and processes, including that entity's attributes and data flow models, such as described within knowledge base 305. Attributes and queries 328 may include a set of queries about an entity utilized for asking a user (such as User 2 as described below) to obtain a desired set of entity attributes. Attributes may include public or private information regarding an entity such as annual revenue, number of employees, jurisdictions where the employees are located, types of data collected and stored from employees, customers and other users, where that data is stored and shared, process controls and processes utilizing that data, etc. That is, attributes may include various limited types of process controls. For example, selling products in the European Union or collecting personal information from European Union residents may result in a determination that the GDPR use case applies. Such a determination of applicability may result in a task of documenting those process controls to determine whether those process controls are in compliance with the applicable GDPR use case rules. Process control models are models of selected process controls generated for performing automatic analysis of those models.

Once these attributes and data flow models have been documented in an entity profile, or as they are being documented, use case rules 303 may then be applied to this obtained set of entity attributes and data flow models to determine whether one or more use cases applies to an entity and/or whether to generate tasks for moving towards compliance and analysis/assessment to the applicable use cases. Rules may be a logical expression for evaluating the applicability of a control or set of controls or whether a particular action or task is needed such as documenting a data flow as a data flow model for further analysis including governance, risk management and compliance (GRC) analysis. Framework 330 may include a structured hierarchy of process controls to which a variety of prior use cases have been applied. Often multiple use cases may utilize the same or similar criteria determining applicability or requirements for achieving compliance and Framework 330 provides a hierarchical listing of such criteria and requirements that can be cross-referenced and utilized across multiple use cases. Framework 330 may also include a set of prior applicability rules, attributes and queries related to those prior use cases for possible utilization with an incoming use case.

Data flow management module 340 includes a User 2 342, also referred to herein as a profile user, interacting with a User 2 GUI 344 to manage the various elements of data flow management module 340. As described in greater detail below with reference to FIG. 4B, User 2 342 may utilize User 2 GUI 344 to generate data flow models of data managed by the entity for storage in knowledge base 305 as well as answer queries from attributes and queries 328 to generate an entity profile including entity attributes, also for storage in knowledge base 305, thereby generating a profile or model of the organizational structure and business process flows of the entity. Also, one or more test profiles may be generated that may be used as a scratchpad of possible test attributes and test data flow models that can be utilized to run “what if” scenarios against use case rules 303 by use case management engine 301. These process controls may be identified and modeled for analysis through tasks as described herein. Use case management engine(s) 301 may apply use case rules 303 against the entity profile, including the data flow models and attributes, stored in knowledge base 305 to generate dashboard 350 for feedback to User 2 as well as other users. User 2 may be a single user, multiple users, a set of users with a given access profile, or other set of users authorized to utilize User 2 GUI 344. User 2 may also be the same as or separate from any other users (e.g., Users 2-4) shown herein. Other users may also access User 2 GUI to manage data flow management 340 as described herein.

Task identification and prioritization management module 360 includes a User 3 362, also referred to herein as a managing user, interacting with a User 3 GUI 364 to manage the various elements of task identification and prioritization management module 360. As described in greater detail below with reference to FIG. 4C, User 3 362 may utilize User 3 GUI 364 to manage the assessment and tasks including approving or rejecting assessments and tasks identified by use case management engine(s) 301, adding additional tasks not identified by use case management engine(s) 301, prioritizing tasks approved or added by User 3. The assessment and tasks may be identified to User 3 for approval or rejection by use case management engine(s) 301 through dashboard 350 or detail report 366. Snapshots of dashboard 350 and detail report 366 may be retained after each change to each of them, or upon each access or viewing of each of them by a user. Dashboard 350 may provide a different level of detail to User 2 and User 3. For example, User 3 may view a full view of assessments and task through dashboard 350 or that greater detail may be provided through detail report 366, whereas User 2 may only view a percentage of completion of the entity profile. As represented as a circled A, User 3 may also access User 2 GUI to make changes to the entity profile stored in knowledge base 305 based on the information received through dashboard 350 and detail report 366.

Task management module 380 includes a User 4 382, also referred to herein as a task user, interacting with a User 4 GUI 384 to manage the various elements of task management module 380. As described in greater detail below with reference to FIG. 4D, User 4 382 may utilize User 4 GUI 384 to perform assigned tasks 309 derived from use cases provided by task identification and prioritization module 360. Tasks can include documenting process controls of data managed by the entity as data flow models for determining whether those data flow models are in compliance with use case criteria and requirements as well as for additional governance and management risk analysis. For example, a user may perform a DPIA (data protection impact assessment) as a task pursuant to a GDPR use case to achieve at least partial compliance with the GDPR use case. To complete data flow documentation tasks, as represented as a circled A, User 4 may utilize User 2 GUI of data flow management module 340.

The automated use case management system described with reference to FIG. 3 is dynamic, adaptable and automated. The use case rules may be modified by User 1, resulting a different assessment and task generation, which would be communicated with User 3 as described herein. The attributes and data flow models of the entity may be modified or updated by User 2, also resulting in a different determination of assessment and task generation, which would also be communicated with User 3 as described herein. User 3 can also approve, add or remove certain use cases and tasks from further assessments and tasks based on intelligent GRC analysis by User 3. In addition, User 3 may initiate a test environment whereby User 3 can make certain test modifications to the attributes and data flow models of the entity to ascertain whether those modifications would result in different assessments and task generation. User 1 may also generate use case rules for future or proposed use cases, which may then be applied against the entity attributes and data flow models to determine whether the future or proposed use cases may generate different assessments and tasks. Of course, User 3 may initiate a test environment to identify impacts of modifications to the entity's attributes against the use case rules for future or proposed use cases. All of these modifications by any of these users may result in an updated assessments and tasks. That is, assessments and tasks may be modified by the use case rules engine against the entity profile automatically, such as upon any modifications to the use case rules by User 1, upon any modifications to the entity attributes or data flow models by User 3, upon the request of User 3, etc. Assessments and tasks may be determined upon any such modifications being provided by any of the users, upon the end of any user session, periodically, etc. based on update criteria set forth by User 3. As a result, with these capabilities, the automated use case management system is dynamic, adaptable and automated.

FIGS. 4A-4D provide high level flow diagrams for each of the multiple interacting modules utilized to manage data flow models for use cases in which various embodiments of the present disclosure may be implemented. Although each flow diagram is described with reference to a single user or set of users, collaboration among these users is enabled and enhanced with the centralized databases, reports and other elements of the system described with reference to FIG. 3. While these flow diagrams are described generally with reference to a single use case, this process may be repeated for multiple use cases including utilizing previously generated elements pursuant to prior use case implementation. In addition, while these flow diagrams are described with reference to a single entity, this process may be repeated for multiple entities, particularly data flow management module 340, task identification and prioritization management module 360 and task management module 380. The flow diagram shown in FIG. 4A may be utilized a single time for a given use case as the use case rules and use case management engine(s) may be utilized across multiple entities or multiple use cases.

FIG. 4A is a high level flow diagram of the operation of system management module 320 to manage process control-based use cases in which various embodiments of the present disclosure may be implemented. In a first step 420, User 1 logs into system management module 320 through GUI 324. This includes verifying the identity and access rights of User 1 to perform the following steps. Although a single user GUI is shown in this module, multiple GUIs may be utilized for various aspects of system management module 320. In a second step 422, an incoming use case, including its criteria for applicability and requirements for compliance, is received and accessed by User 1 through GUI 324 for application to one or more entities. This may be a new use case or an update to a previous use case. User 1 then uses GUI 324 in step 424 to access the framework for mapping the incoming use case against the framework. This includes identifying the various applicability criteria and process control requirements within the incoming use case and identifying where those elements were previously included in framework 330 (referred to herein as mapping the use case against the framework) from previous use cases and identifying gaps where new attributes and new process controls are included in the incoming use case for the given entity. This can include identifying data flow blocks needed for modeling process controls as data flow models sufficiently to determine applicability of the use case to each process control represented as a data flow model and for compliance of the process control with the use case through analysis of the representative data flow models that are applicable. In step 426, the identified gaps for attributes, process controls and data flow blocks may be added to framework 330 as well as attributes and queries 328 and data flow blocks 329. In addition, queries may be developed to supplement the attributes in attributes and queries. Then in step 428, a rule or set of rules for the use case are added or updated to use case rules 303. Furthermore, use case management engine(s) 301 may be updated in step 430 if the new applicability and compliance rules need additional or more complex processing by the use case management engine(s). This process of mapping each use case against the framework may result in filtering and supplementing framework 330, attributes and queries 328, and data flow blocks 329 so that only those attributes and data flow blocks needed for a set of use cases for a given entity are identified in attributes and queries 328 and data flow blocks 329 for that given entity. In addition, this process may reduce or eliminate duplication of those attributes identified in the entity profile. This may reduce the number of total attributes needed for querying User 2 for that given entity such as described below. Furthermore, attributes and queries 328 may only include attributes needed for certain use cases. That is, a user such as User 3 may identify which use cases to be applied with a given entity, thereby possibly reducing the number of attributes and queries applied to that given entity and possibly reducing the number of use cases to be determined as applicable for that given entity by use case management engine 301.

Then in step 432, use case management engine 301 can be rerun with any updated use case rules 303 utilizing the current knowledge base 305 to generate updated dashboard 350, detail report 366 and assessment and tasks 307 for viewing and action by the other users. This may be rerun only for those use case rules 303 and use case management engine 301 that have been updated through the above steps by User 1. Alternatively, use case rules 303 and use case management engine 301 may only be rerun upon the request of User 3. Then in step 434, an audit trail of the use case rules and use case management engines updates is preserved including the identity of User 1, either in the knowledge base as a snapshot or in a separate audit trail database. This audit trail may be generated concurrently with data entry of step 432 or at the end of the data entry session by User 1.

FIG. 4B is a high level flow diagram of the operation of data flow management module 340 to manage an entity profile including data flow models and attributes of that entity in which various embodiments of the present disclosure may be implemented. An entity profile can be utilized across multiple use cases and may not need updating for each use case depending on whether the necessary attributes and data flow models for that entity were previously provided. The following is described as if User 2 is entering both and attributes and data flow models concurrently. However, User 2 may just be entering particular data flow models to complete a task as described below with reference to FIG. 4D.

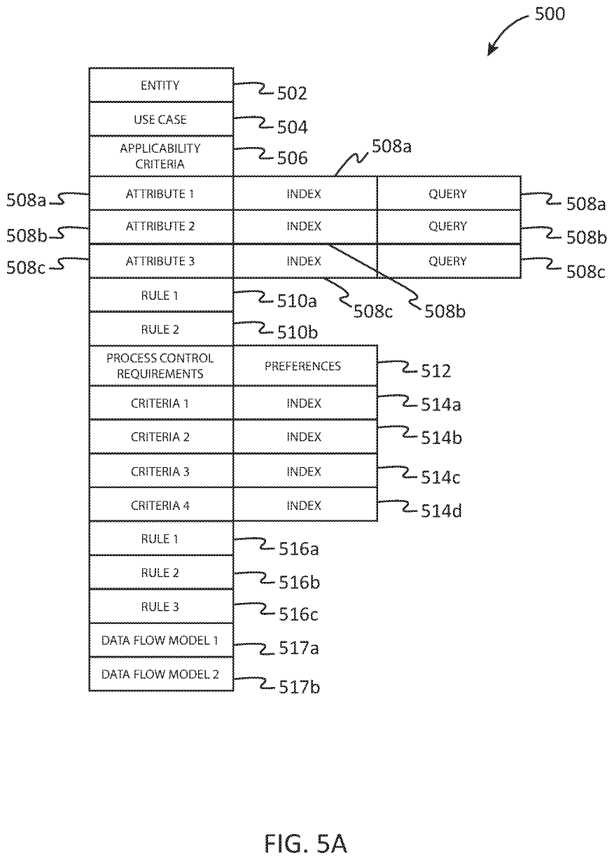

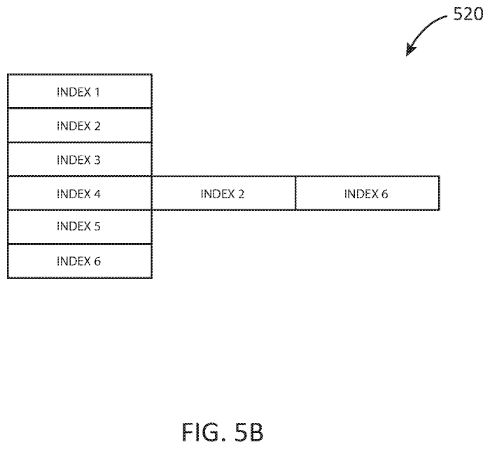

In a first step 440, User 2 logs into data flow management module 340 through GUI 344. This includes verifying the identity and access rights of User 2 to perform the following steps. Although a single GUI is shown in this module, multiple GUIs may be utilized for various aspects of data flow management module 340. In a second step 442, User 2 provides data flow models and attributes of a specific entity through GUI 344, which may be in response to queries, fill in the blank, drop down menus, pop up boxes, etc. to provide the information needed for and as provided in attributes and queries 328 or as required in response to an assigned task 309. This step may include generating a new set of attributes or data flow models for a new entity or updating a previous set of attributes or data flow models for an existing entity. Alternatively, User 2 may be entering one or more test entity profiles, including test attributes and test data flow models, suitable for running “what if” scenarios. A test profile may be created from scratch or by copying and modifying a previous entity or test profile. Attributes and queries 328 may also include explanations of the various attributes and their meaning within the context of one or more use cases. In the present embodiment, the results of answering these queries results in an entity profile from both an organization chart and business process flow points of view in order to determine the scope of laws, regulations, policies and other mandates that apply to that entity. In step 444, typically as the entity attributes and data flow models are provided, they are stored as an entity profile generated in knowledge base 305. Data flow blocks may include nodes and edges representing a set of process controls, each of the nodes and edges having attributes, such as described with reference to FIG. 5 below. In step 446, which may occur concurrently and real time as the entity attributes are provided by User 2 through GUI 344 in step 442, use case management engine(s) 301 could be applying use case rules 303 for one or more use cases against the generated or updated entity profile. In step 448, the results of applying the use case rules against the entity profile are then provided in dashboard 350 and detail report 366. Either or both dashboard 350 and detail report 366 may be updated continuously as User 2 provides the data flow models and entity attributes through GUI 344 or at the end of a data flow models and attributes data entry session by User 2. User 2 may only have limited access to the dashboard and no access to the detail report to avoid influencing the data entered by User 2. That is, User 2 may be influenced by such feedback to modify entity data flow or attribute entry to either seek or avoid certain use case applicability and compliance. As a result, User 2 may only be provided in dashboard 350 with a percentage of completion of entity data flow models and attributes needed to complete an entity profile. In step 450, an audit trail of the entity data flow models and attributes provided and the identity of User 2 are also stored, either in the entity profile as a snapshot or in a separate audit trail database. This audit trail may be generated concurrently with data flow and attributes data entry of step 444 or at the end of the data flow and attributes data entry session by User 2.

FIG. 4C is a high level flow diagram of the operation of task identification and prioritization management module 360 to manage use cases applicable to an entity in which various embodiments of the present disclosure may be implemented. An entity profile can be utilized across multiple use cases and may not need updating for each use case depending on whether the necessary attributes for that entity were previously provided. In a first step 460, User 3 logs into task identification and prioritization management module 360 through GUI 364. This includes verifying the identity and access rights of User 3 to perform the following steps. As will be seen below, typically User 3 will have a higher level of access rights allowing User 3 to make use case applicability decisions as compared to User 2. For example, User 3 may be a chief privacy officer or chief compliance officer of an entity. Although a single GUI is shown in this module, multiple GUIs may be utilized for various aspects of task identification and prioritization management module 360. In a second step 462, User 3 can invoke use case management engine(s) 301 to generate dashboard 350, detail report 366, and assessment and tasks 307 for a given entity and use case. These reports may have already been generated pursuant to the last entity profile data entry session by User 2.

In a third step 464 User 3 may review the use case assessment and tasks generated by use case management engine(s) 301. User 3 may then approve or modify the results of use case management engine(s) 301. If User 3 modifies the results of use case management engine(s) 301, User 3 may either select use cases and tasks as applicable or not regardless of whether they were deemed applicable or not by use case engine(s) 301. As described herein, User 3 or another authorized user can select the level of assessment by use case management engine 301. That is, the level of assessment could be solely towards compliance with the use case, or it could be towards meeting recommended but not required level of maturity with the use case. User 3 may also have an option to log into User 2 GUI for data flow management module 340 to modify the entity profile. These modification to the entity profile, either the attributes or the data flow models, may alter which use cases are applicable and compliant for that entity. User 3 may also have an option to log into User 2 GUI for data flow management module 340 to generate or modify a test version of the entity profile. A test version can be managed similar to an entity profile by User 3 to determine assessments and tasks resulting from that test version. Then in step 466, User 3 may prioritize those tasks generated by use case management engine(s) 301 and well as assign certain tasks to certain persons or entity functional areas. This prioritization may focus attention to and efforts for accomplishing tasks generated pursuant to the applicable higher priority use cases. Based on User 3's approvals, modifications and prioritization, in step 468, the resulting set of tasks are provided to task management module 380 for completion for use in determining and obtaining compliance to the underlying use cases. In step 470, an audit trail of the use cases provided, approved, modified and prioritized with the identity of User 3 are stored, either in the dashboard 350 as a snapshot or in a separate audit trail database. This audit trail may be generated concurrently with use case management by User 3 in steps 464 to 466 or at the end of the use case data management session by User 3.

FIG. 4D is a high level flow diagram of the operation of task management module 380 to manage tasks potentially applicable to an entity in which various embodiments of the present disclosure may be implemented. In a first step 480, User 4 logs into task management module 380 through GUI 384. This includes verifying the identity and access rights of User 4 to perform the following steps. Although a single user GUI is shown in this module, multiple GUIs may be utilized for various aspects of task management module 380. In a second step 482, an incoming assigned task is received and accessed by User 4 through GUI 384 for completion. User 4 then uses GUI 384 in step 484 to complete the assigned task. This can include logging into User 2 GUI 344 for documenting entity data flow models in data flow management module 340. Upon completion of the assigned task, User 3 is notified in step 486 so that User 3 can again invoke use case management engine(s) 301 to determine applicability, compliance and other analysis of the use case such as when certain data flow models are documented.

FIGS. 5A-5B provide block diagrams of database records utilized to manage process control-based use cases in which various embodiments of the present disclosure may be implemented. A record is a set of information within a domain or database that establishes a relationship between a set of data or data elements. A record may be a separate entry into a database, a set of links between data, or other logical relationship between a set of data.

FIG. 5A is a block diagram 500 of a set of records for a selected use case for a certain entity. Additional sets of records may be generated for additional use cases and additional entities. The embodiment shown here can be utilized by many elements described above with reference to FIG. 3 including use case rules 303, attributes and queries 328 and use case management engine 301. Block diagram 500 includes an identified entity 502 and identified use case 504 for entity 502. Identified entity 502 may be an actual entity being modelled or it may be a test entity for performing “what if” scenarios. Use case 504 includes applicability criteria 506 for determining whether use case 504 is applicable for entity 502. Applicability criteria 506 can identify the number of attributes and rules needed to determine this use case applicability. In this example, there are three attributes 508a, 508b and 508c as well as two rules 510a and 510b. Each attribute can include a description of that attribute, an index to framework 330, and a query utilized to obtain the described attribute from the administrative user (e.g., User 1) as described above. The index to the framework may be all that is needed in this database to access the indexed attribute and corresponding query. Process control requirements 512 can identify the number of criteria and rules needed to assess entity 502 with use case 504. Process control requirements 512 can identify the number of criteria and rules needed to make this use case assessment. Process control requirements can also provide a user provided preference of a level of compliance, such as whether to only look at required compliance or recommendations for a mature system beyond required compliance. In this example, there are four criteria 514a, 514b, 514c and 514d as well as three rules 516a, 516b and 516c. Also included are two data flow models 517a and 517b, each including a set of data blocks with attributes. Although only a few criteria and rules are shown for illustrative purposes, many more criteria and rules and data flow models may be utilized for implementing an embodiment of the present invention.

FIG. 5B is a block diagram 520 of a set of records describing the hierarchical relationship among attribute indices to elements of framework 330 and attributes contained in attributes and queries 328. That is, each index refers to a particular attribute of an entity. As described above, attributes may include public or private information regarding an entity such as annual revenue, number of employees, jurisdictions where the employees are located, types of data collected and stored from employees, customers and other users, where that data is stored and shared, data flows and processes utilizing that data, etc. In this embodiment, each index to the framework can be listed including any parent indices for that index. For example, Index 1, index 2 and index 3 do not have any parent indices. However, Index 4 has two parent indices, Index 2 and Index 6. If two indices meet a certain criterion for determining applicability and one of these indices is a subset of or subservient to the other, then the other index is the parent index to the subset or subservient index. For example, if a first index refers to an entity having a privacy officer and a second index refers to an entity having a privacy officer that is also an attorney, the second index is a parent index to the first index. That is, the attribute referred to by the parent index will meet any condition or criteria met by the attribute referred by the first index. Although only a few indices are shown for illustrative purposes, many more indices may be utilized for implementing an embodiment of the present invention. Alternative embodiments may use other techniques for documenting this hierarchical relationship between attributes and indices. This can include the use of codes that indicate a hierarchical relationship. For example, code 1610 may be deemed a parent code to code 1612 as they both start with 161, and 0 can be designated as the parent to all other numbers 1-9. Alternative embodiments could utilize other types of data structures and coding schemes to document hierarchies among the indices.

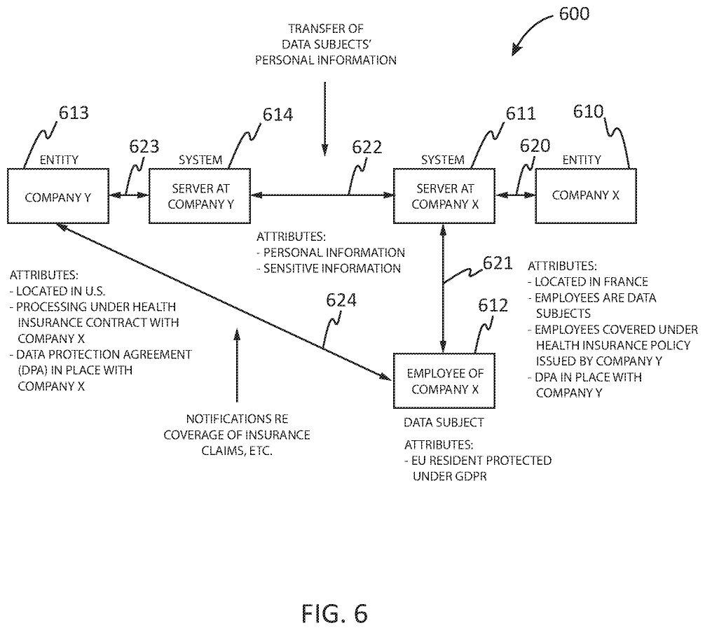

FIG. 6 provides a block diagram of a data flow model representing process controls for use cases in which various embodiments of the present disclosure may be implemented. A data flow model may include nodes and edges, each of which can have various searchable attributes representing the process controls. Nodes may represent data subjects, systems, company entities, third parties (e.g., vendors and/or partners), and data recipients. Edges may represent the connections or pathways between the nodes, including any controls in place for those connections or pathways. This type of data flow modeling enables the use case management engine to apply rules to and perform other analysis of these data flow models and the process controls they represent. In addition, a single data flow model may be utilized and searched for multiple sets of use case rules for multiple use cases. That is, the data flow models are not restricted to a single use case, thereby reducing duplication of effort.

In FIG. 6, a simplified example of a data flow model 600 is shown, including five nodes 610 through 614 and five edges 620 through 624, to represent a selected process control. This model would have been created by User 2 of FIGS. 3 and 4 using data flow blocks 329. In this example, the nodes and edges are associated with various data elements. In this example, node 610 is company X based in Paris, France. Node 611 is a server of company X, which stores and processes personal information of EU residents (Node 612) (e.g., names and locations of company X employees). Some of the personal information is deemed sensitive under the EU GDPR (e.g., employee medical conditions), which is utilized for completing certain health insurance transactions. Node 613 is company Y based in New York, N.Y., the health insurance carrier for company X. Node 614 is a server of company Y which stores (edge 620) and processes personal information (including sensitive medical information) relating to (edge 621) the company X employees in France (Node 612). The personal information of company X's employees needed for health insurance processing is transferred daily (edge 622) from Node 611 to Node 614. The transfer of this data is approved by the General Counsels of company X and company Y as being permitted pursuant to a Data Processing Agreement in place between the two companies, which relies in part on company Y's certification under the EU—U.S. Privacy Shield to meet one control of the GDPR concerning permitted transfers of personal information of EU residents outside of the EU.

This data flow model can then be automatically analyzed by the use case management engine 301 utilizing the use case rules 303. For example, attributes and queries 328 could identify that sensitive personal information of EU residents is being processed by the entity. The entity profile for company y contained in the knowledge base 305 shows that it is based in the U.S., and processes personal information (including sensitive data) of data subjects in France. This would invoke the analysis of process controls required by the GDPR affecting processing of sensitive data as contained in use case criteria and requirements 326. Based on the application of the use case rules 303 for the GDPR when the data flow model involves the processing of sensitive data of EU residents, the use case management engine 301 could generate an assessment and task 307 and assign a task 309 for the conduct of a data protection impact assessment (DPIA). The results of the DPIA could then generate additional assigned tasks 309 through assessment and tasks 307, ultimately resulting in the identification of process controls which need to be implemented in order to comply with the GDPR.

Any node or edge with its attributes, or a subset of its attributes, may be stored in data flow blocks 329 for use by another data flow model. That is, a node representing a database may be utilized in multiple data flow models representing multiple process controls. This helps prevent duplication of effort by users in documenting multiple process controls utilizing a common database or other element being represented by a node or edge. In addition, if a modification is made to a data flow block stored in data flow blocks 329, that modification may automatically be applied to all data flow models utilizing that data flow block unless a user blocks such modifications for a given data flow model. For example, additional sensitive data may be stored in a database accessible by users, necessitating the need to update the attributes of a node representing that database. This update may be stored in data flow blocks 329 resulting in updating the corresponding data flow blocks in knowledge base 305 as an updated entity profile with updated data flow models. As a result, when use case management engine 301 is invoked to run again (which may automatically occur upon a modification to any node or edge in data flow blocks 329) applying use case rules 303 against the updated entity profile in knowledge base 305, new issues of compliance and risk may generate a new assessment and tasks 307, such as the need to update DPIAs of processes that utilize the modified database. This allows for quick identification and notification of issues raised when a database or other element represented by a data block is updated.

This use of data flow models may also be utilized in a production environment. That is, if a modification is made to a database, software controls to that database may also automatically update the node representing that database or automatically notify a user as a task of the modification to the database, necessitating the user to update the corresponding node in the data flow blocks 329, which could result in automatically invoking use case management engine 301 to apply use case rules 303 against the updated knowledge base 305 resulting in a new assessment and tasks 307.

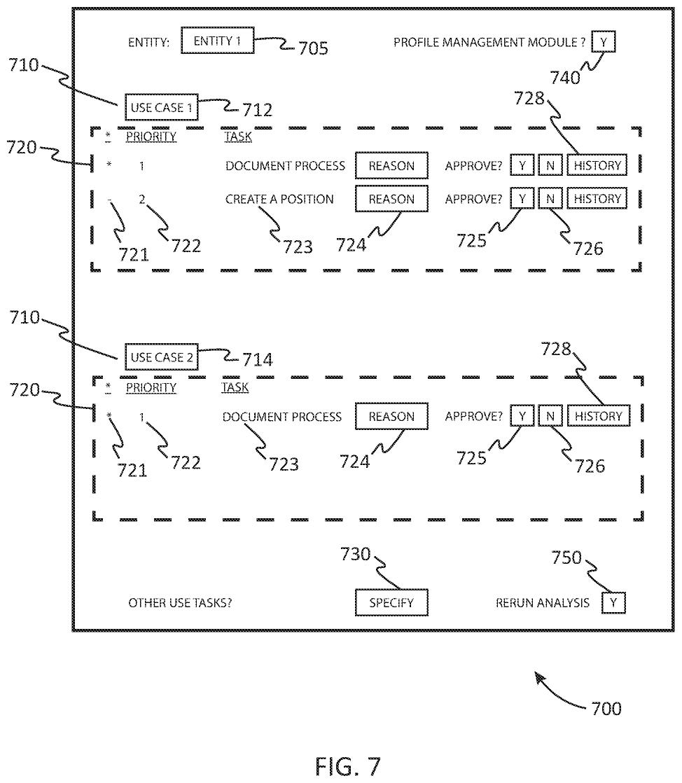

FIG. 7 provides a block diagram of a graphical user interface managing user may use to manage assessments and tasks in which various embodiments of the present disclosure may be implemented. This embodiment is described in support of User 3's (also referred to herein as the managing user) actions in flow diagram of FIG. 4C. In this embodiment, the managing user is able to check the assessment of use cases against various entities and their process controls, approve, add or remove certain tasks, prioritize the tasks, log on the profile management module to modify an entity profile, and rerun the use case assessment.

Graphical User Interface (GUI) 700 is accessible by the managing user as shown above with reference to User 3 of FIG. 4C. Other users may be able to utilize this GUI depending on the configuration of the system. GUI 700 includes a description of the entity 705. This description can be in a pull-down menu to allow the managing user to select other entities, such as test entities. A listing of all applicable use cases analyzed for the entity, shown in entity description 705, are listed in use case listing 710 along with an associated lists of tasks 720. In the present example, only two use case are shown, 712 and 714, one with 2 identified tasks, one with 1 identified task shown in task listing 720. Task listing 720 includes an indication 721 whether the task is required, a priority of each use case 722, a description of each use case 723, reason for applicability box 724, approve applicability 725, remove applicability 726, and history 728. Indication 721 indicates with a “*” in this example whether the task is required or not. As described above, the managing user or other user can provide a preference whether to only include task that are required for compliance of a preference whether to include additional tasks to bring the entity's process controls, or to further improve the maturity of the entity's process controls. Description 723 describes the use case that has been deemed applicable. This may be a full use case such as GDPR, or it may be a portion of a use case with each applicable portion listed separately as applicable or not. Priority 722 is a priority assigned to each task identified. This can be utilized to prioritize any tasks identified from that use case towards achieving compliance or maturity of that use case. Prioritization may be modified the managing user by either changing the prioritization number directly or by selecting and moving lone use case line below or above another use case line. Reason box 724 can be selected to view the reason that use case was deemed applicable. Pressing or clicking reason box 724 can generate a pop-up box or other method for showing the detailed reasons the use case was deemed applicable. The managing user can then select approve task button 725 or remove task button 726 to either approve or remove a task. A history of each task may also be shown by selecting history button 728, allowing the managing user to view a history of the tasks in a pop-up box or other method. Additional space could be provided for assigning the tasks for completion. Also, if a task has already partially been completed, that could be provided though this GUI as well.

GUI 700 provides the managing user the capability of adding tasks not listed above in box 730. These may be tasks towards completing identified tasks, other for other purposes. GUI 700 also provides a link 740 for the managing user to log onto Profile Management module 740. Also provided is a clickable button 750 for rerunning use case management engine 301. This can be useful after the managing user has made modifications to the entity profile or at other times convenient to the managing user. An additional link may be provided for the managing user to view various audit trails generated by the various processes described herein. Other users may also be given this capability, possibly some users with broader viewing rights, other users with narrower viewing rights.

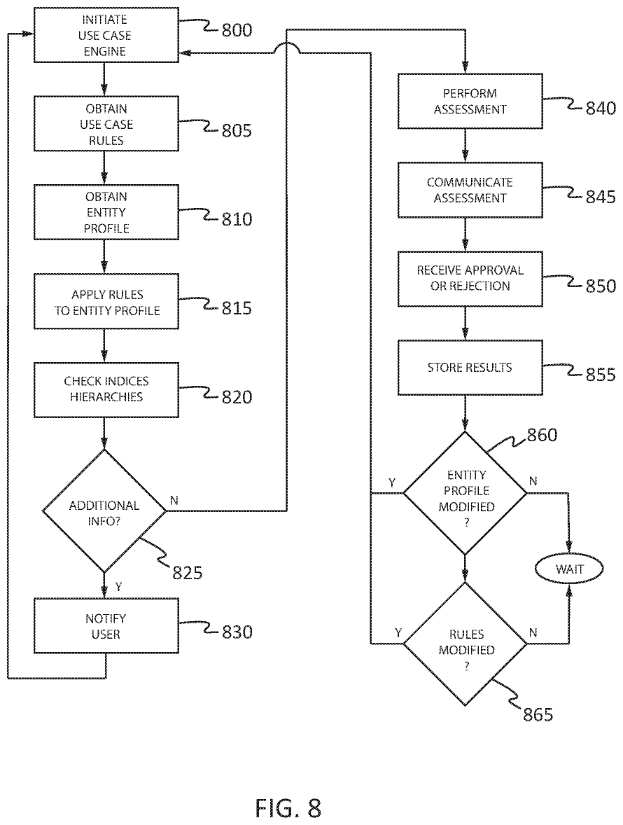

FIG. 8 provides a high-level flow diagram of the use case management engine managing process control-based use cases in which various embodiments of the present disclosure may be implemented. The operation of the use case management engine may be managed internally within the engine itself, or externally by a management element within the dynamically adaptable rules and communication system. This embodiment is directed to the operation of use case management engine 301 for a single entity but could easily be extended to multiple entities. For example, in the case of multiple entities, the use case management engine may run for all entities for all use cases or for just those use cases that have had use case rules changed. Similarly, if the entity profile changes for a single entity, then the use case management engine may run for all use cases for that entity. However, if the entity profile changes for multiple entities, then the use case management engine may run for all entities or for just those entities that have had their entity profiles changed. This embodiment is also directed to a set of use cases, which may include one or multiple use cases. For example, if the use case rules change for a single use case, then the use case management engine may run only for that use case. However, if the use case rules change for multiple use cases, then the use case management engine may run for all use cases or for just those use cases that have had use case rules changed.

In step 800, use case management engine receives a request or is otherwise initiated by circumstances such as described below to apply the use case rules for a given set of use cases for a given entity. In the case of multiple use cases or multiple entities, the following could be performed for all those uses cases and entities. The use case management engine then requests and/or obtains a set of use case rules for the given set of use cases in step 805. Then in step 810, the use case management engine then requests and/or obtains an entity profile for the given entity such as from a knowledge base for that entity. This entity profile includes attributes and data flow models as described herein. The set of use case rules and the entity profile may have been generated as described above with reference to FIGS. 4A-4B. Then in step 815, the use case management engine applies the set of use case rules against selected attributes and data flow models of the entity profile. That is, only certain attributes and data flow models of an entity may be needed for each set of use case rules, so the use case rules are applied against those needed attributes and data flow models. In step 820, as the set of use case rules are applied against the selected attributes and data flow models of the entity profile, corresponding indices to the selected attributes including attributes of the data flow models are also checked in a hierarchical table of indices (also referred to herein as a hierarchy of indexed attributes) such as described above with reference to FIG. 5B. That is, an entity profile may not contain an exact attribute as needed in the use case rules, but a higher-level attribute may be in the entity profile that would meet the requirements of the use case rules.

In step 825, the use case engine indicates whether additional information is needed to fully analyze the entity profile for a given use case. This can occur if there is missing information in the entity profile or other circumstances as set forth in the use case management engine. For example, additional tasks such as completing an entity profile may be needed to perform the use case assessment. If yes in step 825, then in step 830 a managing user may be notified of this indication. The managing user can then correct the shortcoming directly or may generate a task requesting another user, such as a profile user, to correct this shortcoming. This can be accomplished through assessments and tasks 307 assigning tasks 309, or through another process specific to this type of issue. Processing may then return to step 800 until this shortcoming is corrected. If no in step 825, then processing continues to step 840.

In step 840, the use case management engine performs the use case assessment of the entity for the use case in accordance with use case rules and the entity profile as well as assessment level indicated by the entity in preferences. The use case management engine then provides a communication of this assessment to assessment and tasks 307 in step 845, such as to a managing user. This communication may also be made through a dashboard, a report, stored in a database for later retrieval by a user or agent, etc. Upon providing the communication of this assessment, in step 850, use case management engine awaits approval or rejection of the various tasks identified in assessment and tasks 307, such as from the managing user. Upon receiving an approval or rejection of the tasks, the results are stored in a database of assessments and tasks for use cases in step 855.

Then in step 860, the use case management engine awaits an indication that the entity profile has been modified. This could be a general indication of a modification to the entity profile or it could be a specific indication of a modification to an attribute that could affect the use case rules of the given set of use cases. If yes, then processing returns to step 800 above. In addition, in step 865, the use case management engine awaits an indication that the use case rules for the given set of use cases have been modified. If yes, then processing returns to step 800 above. This indication of a modification to the entity profile or the use case rules may be automatically provided to the use case management engine by the GUIs used to make these modifications, automatically by the modules storing the entity profile and the use case rules, upon request of a user, as a result of a periodic query by the use case management engine, etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction processing device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may be processed entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may process the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which are processed via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which are processed on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more performable instructions for implementing the specified logical function(s). In some alternative implementations, the functions noted in the blocks may occur out of the order noted in the Figures. For example, two blocks shown in succession may, in fact, be processed substantially concurrently, or the blocks may sometimes be processed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

A data processing system suitable for storing and/or processing program code will include at least one processor coupled directly or indirectly to memory elements through a system bus. The memory elements can include local memory employed during actual processing of the program code, bulk storage media, and cache memories, which provide temporary storage of at least some program code in order to reduce the number of times code must be retrieved from bulk storage media during processing.

A data processing system may act as a server data processing system or a client data processing system. Server and client data processing systems may include data storage media that are computer usable, such as being computer readable. A data storage medium associated with a server data processing system may contain computer usable code such as for a process controls management system for use cases. A client data processing system may download that computer usable code, such as for storing on a data storage medium associated with the client data processing system, or for using in the client data processing system. The server data processing system may similarly upload computer usable code from the client data processing system such as a content source. The computer usable code resulting from a computer usable program product embodiment of the illustrative embodiments may be uploaded or downloaded using server and client data processing systems in this manner.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The terminology used herein is for the purpose of describing particular embodiments and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A data processing system for performing an assessment of a set of use cases with an entity, the data processing system comprising the steps of:
a processor; and
a memory storing program instructions which when processed by the processor perform the steps of:
receiving a dynamic profile of an entity, the dynamic profile including relevant attributes and a set of data flow models representing process controls for the entity;
receiving a dynamic set of use case rules, each set of use case rules corresponding to at least one of the sets of use cases, for assessing the set of use cases with the entity based on the dynamic profile of that entity;
applying the dynamic set of use case rules against the dynamic entity profile to provide an assessment of the set of use cases with the entity in accordance with the use case rules, the assessment including any tasks to be performed based on the use case rules;
providing the assessment, including tasks to be performed, to a managing user; and responsive to receiving an indication that the dynamic profile of the entity has been modified, automatically repeating the step of applying the dynamic set of use case rules against the dynamic entity profile to provide an assessment of the set of use cases with the entity and, automatically repeating the step of providing the assessment to the managing user

2. The data processing system of claim 1 wherein the step of automatically repeating the step of applying and the step of providing is responsive to modification to the set of data flow models of the dynamic profile of the entity.

3. The data processing system of claim 2 wherein the set of data flow models include a first data flow model with at least one node derived from a library of data flow blocks; and wherein a modification to the at least one node results in an automatic modification to the first data flow model which results in a modification of the set of data flow models.

4. The data processing system of claim 1 wherein the set of data flow models include a set of nodes; each of the set of nodes having searchable attributes.

5. The data processing system of claim 1 further comprising:
obtaining a preferred level of assessment for the entity;
responsive to the preferred level of assessment, limit applying the dynamic set of use case rules against the dynamic entity profile to a subset of the use case rules required for compliance with the set of use cases.

6. The data processing system of claim 1 wherein the step of applying the dynamic set of use case rules against the dynamic entity profile includes checking a hierarchy of indexed attributes for providing an assessment.

7. A computer program product for performing an assessment of a set of use cases with an entity, the computer program product comprising a computer readable storage medium having program instructions embodied therewith, the program instructions processed by a processing circuit to cause the device to perform a method comprising the steps of:
receiving a dynamic profile of an entity, the dynamic profile including relevant attributes and a set of data flow models representing process controls for the entity;
receiving a dynamic set of use case rules, each set of use case rules corresponding to at least one of the sets of use cases, for assessing the set of use cases with the entity based on the dynamic profile of that entity;
applying the dynamic set of use case rules against the dynamic entity profile to provide an assessment of the set of use cases with the entity in accordance with the use case rules, the assessment including any tasks to be performed based on the use case rules;
providing the assessment, including tasks to be performed, to a managing user; and responsive to receiving an indication that the dynamic profile of the entity has been modified, automatically repeating the step of applying the dynamic set of use case rules against the dynamic entity profile to provide an assessment of the set of use cases with the entity and, automatically repeating the step of providing the assessment to the managing user

8. The computer program product of claim 7 wherein the step of automatically repeating the step of applying and the step of providing is responsive to modification to the set of data flow models of the dynamic profile of the entity.

9. The computer program product of claim 8 wherein the set of data flow models include a first data flow model with at least one node derived from a library of data flow blocks; and wherein a modification to the at least one node results in an automatic modification to the first data flow model which results in a modification of the set of data flow models.

10. The computer program product of claim 7 wherein the set of data flow models include a set of nodes; each of the set of nodes having searchable attributes.

11. The computer program product of claim 7 further comprising:
obtaining a preferred level of assessment for the entity;
responsive to the preferred level of assessment, limit applying the dynamic set of use case rules against the dynamic entity profile to a subset of the use case rules required for compliance with the set of use cases.

12. The computer program product of claim 7 wherein the step of applying the dynamic set of use case rules against the dynamic entity profile includes checking a hierarchy of indexed attributes for providing an assessment.

13. A method of performing an assessment of a set of use cases with an entity comprising the steps of:
receiving a dynamic profile of an entity, the dynamic profile including relevant attributes and a set of data flow models representing process controls for the entity;
receiving a dynamic set of use case rules, each set of use case rules corresponding to at least one of the sets of use cases, for assessing the set of use cases with the entity based on the dynamic profile of that entity;
applying the dynamic set of use case rules against the dynamic entity profile to provide an assessment of the set of use cases with the entity in accordance with the use case rules, the assessment including any tasks to be performed based on the use case rules;
providing the assessment, including tasks to be performed, to a managing user; and
responsive to receiving an indication that the dynamic profile of the entity has been modified, automatically repeating the step of applying the dynamic set of use case rules against the dynamic entity profile to provide an assessment of the set of use cases with the entity and, automatically repeating the step of providing the assessment to the managing user.

14. The method of claim 13 wherein the step of automatically repeating the step of applying and the step of providing is responsive to modification to the set of data flow models of the dynamic profile of the entity.

15. The method of claim 14 wherein the set of data flow models include a first data flow model with at least one node derived from a library of data flow blocks; and wherein a modification to the at least one node results in an automatic modification to the first data flow model which results in a modification of the set of data flow models.

16. The method of claim 13 wherein the set of data flow models include a set of nodes; each of the set of nodes having searchable attributes.

17. The method of claim 16 wherein the set of data flow models further include a set of edges, each of the edges having searchable attributes.

18. The method of claim 13 further comprising:
obtaining a preferred level of assessment for the entity;
responsive to the preferred level of assessment, limit applying the dynamic set of use case rules against the dynamic entity profile to a subset of the use case rules required for compliance with the set of use cases.

19. The method of claim 13 wherein the step of applying the dynamic set of use case rules against the dynamic entity profile includes checking a hierarchy of indexed attributes for providing an assessment.

20. The method of claim 13 further comprising:
receiving a communication from the managing user, responsive to the provided assessment, of a set of use case related tasks assigned to a set of users; and
automatically notifying the set of users or the set of use case related tasks assigned to that set of users.
